(19) United States
(12) Patent Application Publication
(10) Pub. No.: US 2025/0078392 A1
(43) Pub. Date: Mar. 6, 2025

(54) MULTI-VIEW 3D DIFFUSION

(71) Applicant: Lemon Inc., Grand Cayman (KY)

(72) Inventors: Yichun SHI, Los Angeles, CA (US); Peng WANG, Los Angeles, CA (US); Jianglong YE, Los Angeles, CA (US); Long MAI, Los Angeles, CA (US); Xiao YANG, Los Angeles, CA (US); Xiaohui SHEN, Los Angeles, CA (US)

(21) Appl. No.: 18/238,780

(22) Filed: Aug. 28, 2023

(51) Int. Cl. G06T 15/20; G06N 3/0455; G06N 3/096

(52) U.S. Cl. CPC G06T 15/205; G06N 3/0455; G06N 3/096

(57) ABSTRACT

An image generation system is described. The system comprises a neural network model configured to perform a diffusion process to generate a set of multi-view images from a same input prompt. The set of multi-view images have a same subject from different view orientation. The neural network model comprises a self-attention layer configured to relate pixels across the set of multi-view images.

### BACKGROUND

3D content creation is an important step in the pipeline of modern game and media industry, yet it is a labor-intensive task that requires well-trained designers to work for hours or days to create a single 3D asset. A system that can generate 3D content in a simplified way by casual users is thus of great value. Existing 3D generation methods may be categorized into three types: traditional template-based generation pipeline, 3D generative models, and 2D-lifting methods. The template-based pipelines, such as MetaHuman, are the most mature methods for generating 3D content, since they focus on adjusting parameters on pre-defined templates. However, they are often limited to certain types of common objects or subjects (e.g., a person's face) and may have difficulty generalizing their output to other types of objects that do not have a pre-defined template. Powered by deep learning methods, researchers from academia have been training neural networks as 3D generative models, including 3D Variational Auto Encoders, 3D Generative Adversarial Models, and 3D diffusion models. However, because of limited availability of 3D models and large data complexity, these models may also have difficulty generalizing their output to generate an arbitrary object.

2D lifting methods have been developed to use pre-trained 2D prior models for 3D asset generation. For example, Dreamfusion and magic3D systems utilize 2D diffusion models for 3D generation. Trained on large-scale 2D image datasets, such models have a good knowledge of real world objects and excellent generalizability. Nevertheless, because these models only have a 2D knowledge of objects, they provide a single view supervision, which often results in assets generated by these methods having issues with multi-view consistency. In other words, the 3D object generated from a single view of a 2D image may be inconsistent when viewed from different directions. For example, problems caused by insufficient multi-view knowledge or 3D-awareness of 2D diffusion models during score distillation may include a multi-face Janus problem where the system tends to generate repeated content described by the text prompt, and drifting content from different views.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure are directed to image processors for image generation.

In some aspects, an image generation system is provided. The image generation system comprises a neural network model configured to perform a diffusion process to generate a set of multi-view images from a same input prompt. The set of multi-view images having a same subject from different view orientations. The neural network model comprises a self-attention layer configured to relate pixels across the set of multi-view images.

In some aspects, the neural network model comprises a view encoder configured to generate respective view embeddings as inputs that represent the different view orientations.

In some aspects, each view embedding is combined with a corresponding diffusion timestep as a residual for the neural network model.

In some aspects, the neural network model further comprises a cross attention layer configured to receive a text embedding that represents the same input prompt, wherein the text embedding is combined with the view embeddings.

In some aspects, the view encoder is a multi-layer perceptron.

In some aspects, the neural network model is trained using a plurality of sets of 3D images, each 3D image within a set of 3D images having a same subject and a different view orientation.

In some aspects, a diffusion timestep is shared among each 3D image within the set of 3D images.

In some aspects, the neural network model is further trained using a plurality of individual 2D images having different subjects from each other.

In some aspects, the view embedding is omitted for the plurality of individual 2D images.

In some aspects, the neural network model is based on a pre-trained 2D diffusion model for transfer learning and is fine-tuned using the plurality of individual 2D images and the plurality of sets of 3D images.

In other aspects, a method for training an image processor having a neural network model is provided. The method comprises generating a first training batch that comprises a plurality of sets of 3D images. Each 3D image within a set of 3D images has a same subject and a different view orientation. The method further comprises generating respective view embeddings as inputs for the neural network model that represent the different view orientations. The method further comprises training the neural network model of the image processor for multi-view image diffusion using the first training batch and the view embeddings.

In some aspects, training the neural network model of the image processor comprises relating pixels across images within a set of 3D images using a self-attention layer of the neural network model.

In some aspects, training the neural network model of the image processor comprises combining the respective view embeddings with a corresponding diffusion timestep as a residual for the neural network model.

In some aspects, each 3D image within the set of 3D images corresponds to a same input prompt, and training the neural network model comprises: generating a text embedding that represents the same input prompt, wherein the text embedding is combined with the view embeddings; and providing the text embedding to a cross attention layer of the neural network model.

In some aspects, generating the respective view embeddings comprises generating the respective view embeddings using a multi-layer perceptron.

In some aspects, generating the first training batch that comprises the plurality of sets of 3D images comprises generating 3D images, for each set of 3D images, to have view orientations having a same elevation angle at uniformly distributed azimuth angles.

In some aspects, generating the first training batch further comprises generating a plurality of individual 2D images having different subjects from each other.

In some aspects, training the neural network model further comprises pre-training the neural network model as a 2D diffusion model for transfer learning; and fine-tuning the neural network model using the plurality of sets of 3D images and the plurality of individual 2D images.

In some aspects, fine-tuning the neural network model comprises: receiving a plurality of identity text/image pairs of a subject; and fine-tuning parameters of the neural network model using a parameter preservation loss.

In some aspects, training the neural network model comprises sharing a diffusion timestep among each 3D image within the set of 3D images.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS/FIGURES

Non-limiting and non-exhaustive examples are described with reference to the following Figures.

FIG. 1 shows a block diagram of an example of an image generation system, according to an example embodiment.

FIG. 2A shows an example self-attention pattern according to the prior art.

FIGS. 2B, 2C, and 2D show example images of multi-view issues when using 2D lifting methods.

FIG. 3 shows a block diagram of an example image processor for multi-view 3D diffusion, according to an example embodiment.

FIG. 4 shows an example self-attention pattern for 3D cross frame self-attention, according to an embodiment.

FIG. 5 shows a flowchart of an example method for training an image processor having a neural network model, according to an example embodiment.

FIG. 6 is a block diagram illustrating example physical components of a computing device with which aspects of the disclosure may be practiced.

FIGS. 7 and 8 are simplified block diagrams of a computing device with which aspects of the present disclosure may be practiced.

FIG. 9 shows a block diagram illustrating an example process for fine tuning a neural network model, according to an example embodiment.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure describes various examples of an image generation system having a neural network model and method for training the image generation system. The image generation system generates output images, such as 3D images, or even 3D models, using a neural network model. Generally, the image generation system provides a lifting method for 3D generation with improved multi-view consistency. More specifically, the image generation system generates multi-view geometrically consistent images from a given text or single-view image input. In various aspects, instead of directly utilizing pre-trained 2D diffusion priors for 3D generation, a diffusion model may be converted into multi-view diffusion models, where a joint distribution of multiple views of the same subject is learned by the diffusion model. Advantageously, the diffusion model both inherits the generalizability of 2D priors and learns the multi-view consistency from rendered data. Applying this diffusion model to 2D lifting leads to improved multi-view image stability compared to traditional 2D lifting methods. An example image generation system may include a neural network model configured to perform a diffusion process to generate a set of multi-view images from a same input prompt. The set of multi-view images have a same subject from different view orientations (e.g., front view orientation, side view orientation, etc.). The neural network model comprises a self attention layer configured to relate pixels across the set of multi-view images.

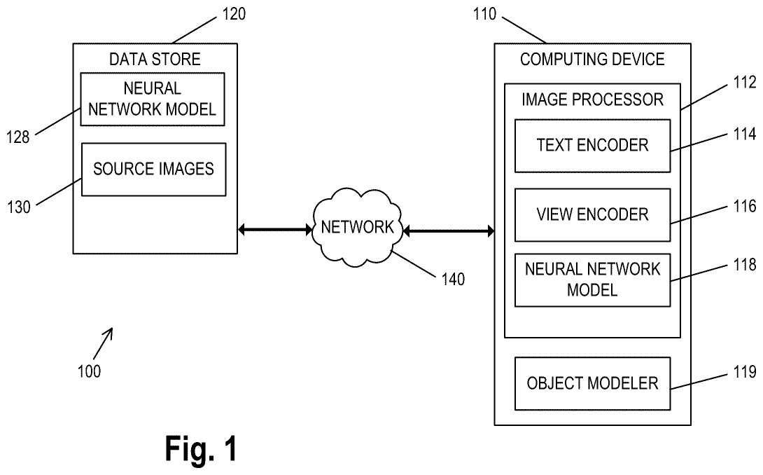

This and many further embodiments for a computing device are described herein. For instance, FIG. 1 shows a block diagram of an example of an image generation system 100, according to an example embodiment. Generally, the image generation system 100 is configured to simultaneously generate a set of multi-view images that are consistent with each other. In some examples, the image generation system 100 uses a similar architectural design of a diffusion model, but adapted to multi-view image generation. This allows the use of pre-trained diffusion models for transfer learning and the resulting multi-view diffusion model may inherit the generalizability of the diffusion models. In some examples, the pre-trained diffusion model is a 2D diffusion model.

The system 100 includes a computing device 110 that is configured to train a neural network model, such as a neural network model 118 of image processor 112 or neural network model 128, using source images 130. The computing device 110 includes the image processor 112, which is configured to process images for training the neural network model 118. The system 100 may also include a data store 120 that is communicatively coupled with the computing device 110 via a network 140, in some examples. In some examples, the computing device 110 includes a first neural network model 118 for a diffusion model and a second neural network model (not shown) for a 3D model generation, described below.

Generally, the source images 130 are images that represent an object or group of objects, a person or group of people, or other suitable subject. In some examples, some or all of the source images 130 are generated by a 2D or 3D rendering module and snapshots or screenshots are captured based on an output of the rendering module or content on a display (e.g., computer monitor or smartphone screen). In other examples, the source images 130 are images captured by a digital camera, digital image processor, an image capture module (e.g., of a webcam or smartphone), or other suitable image capture device.

The source images 130 include at least some images that form different sets of multi-view images having a same subject from different view orientations. For example, a first set of multi-view images may have a bulldog wearing a pirate hat as a subject and the multi-view images may have four images with a front view orientation, a left side view orientation, a right side view orientation, and a rear view orientation, respectively. A second set of multi-view images may have a different subject (e.g., a red sports car) and four images with the front view orientation, the left side view orientation, the right side view orientation, and the rear view orientation.

In the examples described herein, each set of multi-view images generally has one subject, four images, and four view orientations, with each image having a different view orientation. Moreover, each image is cropped or processed to generally center the subject within the image. In other examples, sets of multi-view images may have different numbers of subjects (e.g., two or more), different numbers of images (e.g., two, three, five, six, etc.), different numbers of view orientations (e.g., two view orientations, three view orientations, etc.). In some examples, a first set may have four images of a first subject, a second set may have seven images of a second subject, etc. In still other examples, different sets may have different view orientations. Moreover, the different view orientations may have any suitable combination of coordinates in a 3D space (e.g., x, y, z coordinates) and orientations (e.g., a polar angle θ and azimuthal angle ϕ).

The computing device 110 may be any type of computing device, including a smartphone, mobile computer or mobile computing device (e.g., a Microsoft® Surface® device, a laptop computer, a notebook computer, a tablet computer such as an Apple iPad™, a netbook, etc.), or a stationary computing device such as a desktop computer or PC (personal computer). The computing device 110 may be configured to communicate with a social media platform, cloud processing provider, software as a service provider, or other suitable entity, for example, using social media software and a suitable communication network. The computing device 110 may be configured to execute one or more software applications (or “applications”) and/or services and/or manage hardware resources (e.g., processors, memory, etc.), which may be utilized by users of the computing device 110.

In the example shown in FIG. 1, the image processor 112 includes a text encoder 116 and a view encoder 114. In other examples, the text encoder 116 and the view encoder 114 may be formed as a combined processor. In some examples, at least some portions of the text encoder 116 and the view encoder 114 may be combined with the neural network model 118, for example, by including a neural network processor or other suitable processor configured to implement a neural network model. In other words, the neural network model 118 may be integral with the text encoder 116 and the view encoder 114 and implemented with, or as, a neural network processor. In some examples, the neural network model 118 is omitted from the computing device 110 and the neural network model 128 is utilized instead.

The neural network model 118 is trained using the image processor 112 and configured to process an input prompt to provide a set of multi-view images of a subject. In some examples, the neural network model 118 is implemented at least in part using a variational autoencoder. The neural network model 128 is generally similar to the neural network model 118, but is stored remotely from the computing device 110 (e.g., at the data store 120). Generally, the input prompt is a text input that describes a desired subject or conditions for the generated images. The text input may be in a natural language format. In other words, the prompt may be written in a conversational way that is readily understood by users (e.g., casual users of a social media platform), even without special training on computers or neural network models. In some examples, the prompt may combine natural language with other information in a suitable text data format, such as a text-based vector of elements. Generally, the text encoder 116 is configured to encode the text input into a vector (e.g., text embedding) as an input for the neural network model 118 (e.g., an input for a cross attention layer). Similarly, the view encoder 114 is configured to encode a view orientation into a vector or matrix, for example, as an input for the neural network model 118.

The image processor 112 may be similar to Stable Diffusion, DALL-E, Imagen, Midjourney, or other suitable text to image processors, with additional features as described herein. In the examples described herein, the image processor 112 is a diffusion model, having a noise processor configured to iteratively denoise a noisy image through a number of layers. Denoising of the image is based on a prompt that conditions the noise processor, as described below.

The computing device 100 may also comprise an object modeler 119, which may be configured to generate a suitable 3D object or model based on a set of multi-view images, as described below.

Data store 120 may include one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium. The data store 120 may store the neural network model 128 and/or source images 130 (e.g., images for training the neural network models 118 and/or 128), for example. In some examples, the data store 120 provides the source images 130 to the image processor 112 for training the neural network model 118 and/or the neural network model 128. In some examples, one or more data stores 120 may be co-located (e.g., housed in one or more nearby buildings with associated components such as backup power supplies, redundant data communications, environmental controls, etc.) to form a datacenter, or may be arranged in other manners. Accordingly, in an embodiment, one or more of data stores 120 may be a datacenter in a distributed collection of datacenters.

Network 140 may comprise one or more networks such as local area networks (LANs), wide area networks (WANs), enterprise networks, the Internet, etc., and may include one or more of wired and/or wireless portions. Computing device 110 and data store 120 may include at least one wired or wireless network interface that enables communication with each other (or an intermediate device, such as a Web server or database server) via network 140. Examples of such a network interface include but are not limited to an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, or a near field communication (NFC) interface. Examples of network 140 include a local area network (LAN), a wide area network (WAN), a personal area network (PAN), the Internet, and/or any combination thereof.

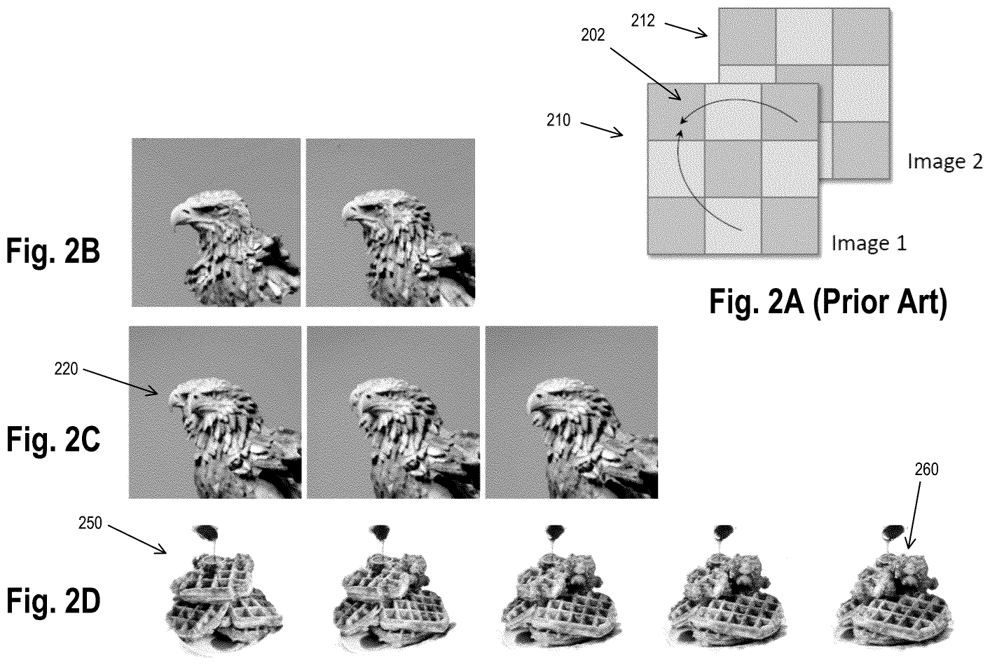

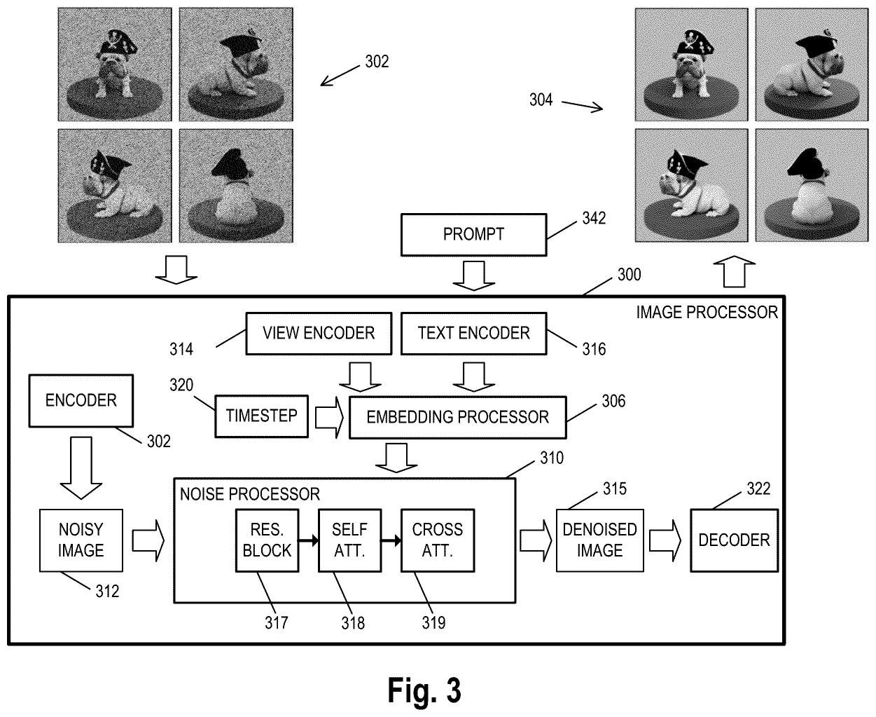

FIG. 2A shows an example self-attention pattern 202 according to the prior art. In FIG. 2A, a first image 210 and a second image 212 are processed by a prior art 2D diffusion model having a self-attention layer trained only for individual images. In other words, the training does not take into consideration that features of a subject may appear in multiple images having different view orientations.

FIGS. 2B, 2C, and 2D show example images of multi-view issues using 2D lifting methods. In FIG. 2B and FIG. 2C, five images showing a multi-face Janus problem are provided, where the system tends to generate repeated content described by the text prompt. For example, FIGS. 2B and 2C show different views of an eagle, but a beak 220 of the eagle is repeated within some images (i.e., in the third image and fourth images). In FIG. 2D, five images showing drifting content from different views are provided, where the system tends to generate a portion 250 of a subject (i.e., an edge of a waffle) that has drifted from one subject (the waffle) to a different subject 260 (i.e., a piece of fried chicken).

The multi-face problem may be caused by various reasons. For some subjects, such as a knife blade, the object might be nearly invisible from certain view orientations (e.g., looking at the edge of the knife blade). As another example, an animal as a subject may have a portion (e.g., a long tail) that is self-occluded by a body of the animal and cannot be seen from some perspectives. When these subjects are evaluated by a person, the person may observe the subject from different perspectives in a joint way, with memory of previously viewed perspectives, but a 2D diffusion model does not coordinate different perspectives, thus it may tend to generate repeated content. To overcome this lack of multi-view awareness for a subject, the image generation system 100 is configured to provide self-attention to multiple views of a same subject, as described herein.

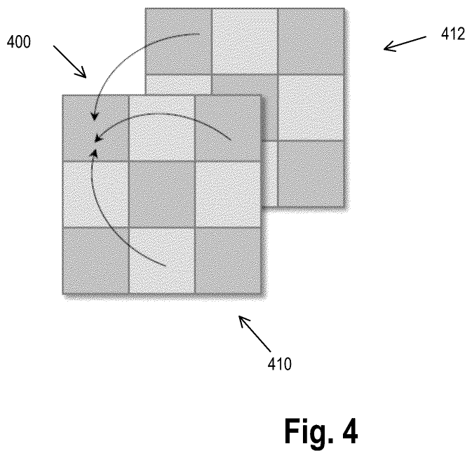

FIG. 3 shows a block diagram of an example of an image processor 300, according to an example embodiment. The image processor 300 generally corresponds to the image processor 112 and generates sets of images having improved multi-view consistency. The image processor 300 is configured to generate a set of output images 304 based on a suitable prompt 342. As described above, the image processor 300 may, in some examples, correspond to a Stable Diffusion neural network model that performs a denoising process based on the prompt 342 to generate the set of output images 304. Generally, the prompt 342 may be a caption or sentence for an image, text-based description of an image (or group of images), or other suitable text prompt for image generation. The prompt 342 may be a text field, string, or other characters that combines natural language with other information in a suitable text data format, such as a text-based vector of elements, for example. Generally, the prompt 342 is used to condition the image processor 300, thereby influencing the output images 304. The prompt 342 may represent a desired image style and/or subject for the output images 304.

In the example shown in FIG. 3, the image processor 300 is based on the UNet text-to-image diffusion model, but with adaptations to allow for providing a set 302 of multi-view images as a batch during training and changing a self-attention layer from 2D to 3D to allow for connections between different view orientations for images within a same batch. Moreover, the image processor 300 generates view embeddings for encoding the different view orientations of the images within the batch. Generally, the image processor 300 comprises an encoder 302, a noise processor 310, a view encoder 314, a text encoder 316, an embedding processor 306, and a decoder 322. The encoder 302 and decoder 322 may operate as a variational auto encoder. For example, the encoder 302 may generate a noisy image 312 by introducing noise to an input image. The introduced noise may be Gaussian noise, pseudo-random noise, or other suitable noise.

The noise processor 310 comprises a plurality of processing layers 317, 318, 319 that iteratively denoise the noisy image 312 to generate a denoised image 315. The decoder 322 processes the denoised image 315 to generate the output images 304. In some examples, the noise processor 310 is implemented as a UNet model, further adapted as described herein. Generally, the noise processor 310 attempts to predict the noise introduced to the input image 302 and a suitable loss function (e.g., L2 reconstruction loss) is used to train the noise processor 310. In some examples, the decoder 322 comprises an upsampling processor or neural network model configured to generate a high resolution image (e.g., 512×512 or more) from a low resolution image (e.g., 64×64 or less).

As described above, the noise processor 310 comprises a plurality of processing layers (or blocks) 317, 318, and 319 that iteratively denoise the noisy image 312 to generate the denoised image 315. The processing layers may include multiple instances of residual layers 317, self-attention layers 318, and cross attention layers 319, arranged in an interleaved pattern. Although only three layers are shown in FIG. 3 for clarity, the noise processor 310 may have additional layers. For example, the noise processor 310 may have additional types of layers (e.g., normalization layers) or additional instances of the residual layers, attention layers, etc.

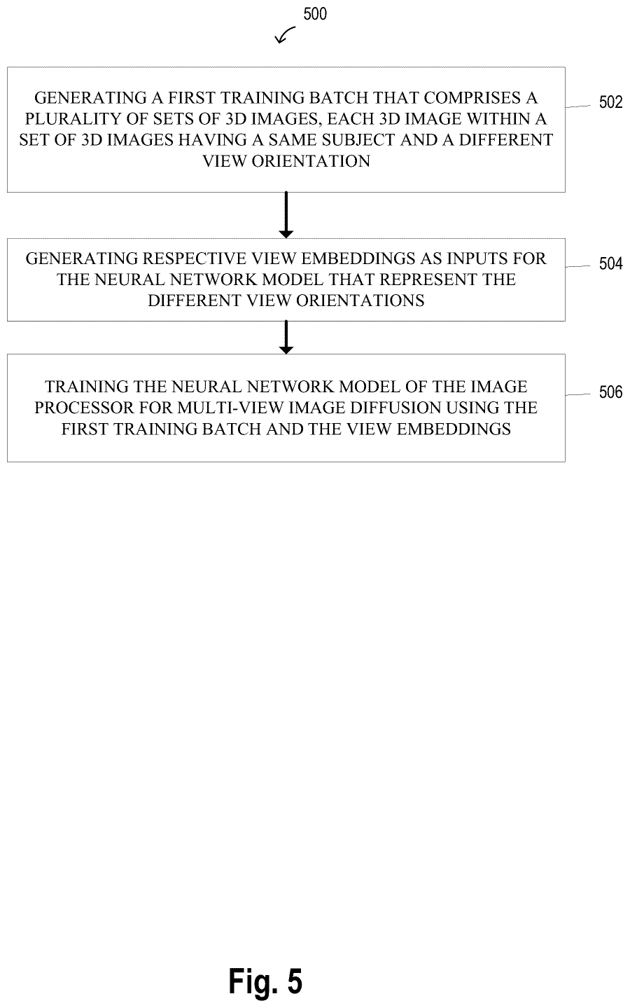

Referring to FIG. 4, the self-attention layer 318 of the noise processor 310 may be trained to have a self-attention pattern 400 for 3D cross frame self-attention, as an example. More specifically, the self-attention layer 318 models a long range dependency between different pixels in a set of images, where pixels for features from the different images within the set (having different view orientations) can connect to each other.

The view encoder 314 is configured to generate the view embeddings as inputs to the noise processor 310, representing the different view orientations within a set of images. In some examples, the view encoder 314 is implemented as a two layer multi-perceptron. To provide the view embeddings to the noise processor 310, the embedding processor 306 may add each view embedding to a corresponding time embedding (i.e., a timestep 320 for diffusion) as residuals, or alternatively, the embedding processor 306 may append the view embeddings to text embeddings (i.e., from text encoder 316 for the prompt 342) for the cross attention layer 319. In diffusion models, a noise level is controlled by the timestep t, and, in the case of the noise processor 310, a same timestep t is shared among multi-view images in a set. Combining the view embedding with the timestep may be preferable in some scenarios where the view orientation is less entangled with the prompt 342. Advantageously, by adding the view embeddings to the timestep, the view embeddings may be readily omitted for processing 2D images without view information and the noise processor 310 may use same weights for both individual 2D images and sets of multi-view images.

The text encoder 316 is configured to process the prompt 342 to generate an encoded prompt or text embeddings (not shown) that condition at least some of the processing layers of the noise processor 310. In some examples, the text encoder 316 is a pretrained transformer language model which transforms a text prompt to an encoded prompt (e.g., an embedding space). In one such example, the text encoder 316 is the CLIP ViT-L/14 text encoder that generates the encoded prompt.

Training of the image processor 300 may be performed using only sets of multi-view images having a same subject, or both sets of multi-view images having a same subject and individual 2D images. In some examples, both the sets and individual 2D images are used to allow for transfer learning. In one example, the image processor 310 is based on a pre-trained 2D diffusion model for transfer learning and is fine-tuned using a training batch having plurality of individual 2D images and a plurality of sets of 3D images. The training batch may have 70% of its images be from the sets of 3D images and 30% of its images may be from the 2D images, as one example.

The computing device 110 may generate suitable sets of 3D images for training the image processor 112 (image processor 300) by rendering a set of multi-view images for each subject from a real 3D dataset, such as Objaverse. Advantageously, rendering the set of 3D images from a known model allows for known ground truths for both view orientation and a consistent scene (i.e., not an animated or moving subject). Relevant factors for generating a training batch include a choice of view orientations, a number of images, a resolution of the images, and joint training with original text-to-image datasets (e.g., a dataset from Large-scale Artificial Intelligence Open Network). By jointly training the image processor 112 on multi-view images and images from a text-to-image dataset, the image processor 112 may achieve improved consistency and generalizability for sets of output images 304.

Generally, a set of multi-view images (e.g., input images 302) is generated using different view orientations that are uniformly distributed at a same elevation angle. The elevation angle may be randomly or pseudo-randomly chosen between 0 and 30 degrees. Adding elevation angle beyond this range may degrades the generation quality, in some examples. A relatively high number of view orientations may also increase convergence difficulty, so the set 302 of multi-view images includes four view orientations. In other examples, additional or fewer view orientations may be used, for example, depending on available processing resources for training, etc.

In some examples, the image processor 300 is configured to generate a set of multi-view consistent images of the same scene from different perspectives such that the images may be used as a multi-view prior for subsequent tasks in 3D generation. In other words, the image processor 300 may generate multiple images of an object based on a text prompt, and those images may be used to generate a suitable 3D asset or model. In some examples, 3D generation is performed using a multi-view score distillation process. In other examples, 3D generation is performed using a suitable 3D reconstruction technique. Score distillation and/or 3D reconstruction may be performed by the object modeler 119, for example.

Score distillation may be used to lift a 2D prior into 3D content. For example, in dreamfusion, a random NeRF (neural radiance field) is initialized to represent a 3D object. At every step during optimization, a random view is rendered from the NeRF and is supervised by the 2D image diffusion model via score distillation sampling (SDS). Specifically, random noise is added to the rendered image. Given the noisy image, the diffusion model predicts the noise, whose difference from the ground truth noise is used as the gradient of the rendered image. This approach may be considered an approximation of minimizing the KL-divergence (Kullback-Leibler, a generalization of squared distance) between two distributions: a first distribution from the NeRF and a second distribution from the diffusion prior. However, this approach supervises the text-image correspondence of a single view at a time and thus does not have suitable multi-view consistency. Even when a view orientation is explicitly mentioned in a text input (e.g., “front view”, “back view”), multiple view consistency is an issue.

The object modeler 119 may be configured to, assuming a 4-view set of multi-view images, at each training step, generate four views of a given NeRF. These four images are then provided into the multi-view diffusion model (e.g., image processor 300) for score distillation. In this way, the image processor 300 jointly supervises text-image correspondence and multi-view consistency, leading to more coherent 3D content. In a similar manner to the training phase, the same timestep t is shared between different views during SDS. The ground truth view orientation used for rendering is input into the view encoder 314 to generate a suitable view embedding.

In some examples, multi-view diffusion by the image processor 300 may be conditioned on an input image. Moreover, an image-conditioned set of multi-view images may be used for 3D generation. Image conditioned multi-view diffusion may be achieved by replacing the prompt 342 of the image processor 300 with image conditions. In some examples, image conditions are provided using image embeddings in the cross attention layers 319. Alternatively, in other examples, images are added into the input space with noisy images (e.g., noisy image 312). Note that the image condition here may be a single input image or a set of multi-view images. Accordingly, two different pipelines may be used for image conditions. A first pipeline for single view images may include a single concept image that is generated with a suitable image diffusion model (e.g., stable diffusion) and, using the concept image as an input to the image processor 300 without a view embedding. For a second pipeline for multi-view images, a multi-view concept image is generated using the image processor 300 with a prompt 342, and the multi-view concept image is further provided as an input to the image processor 300 with the view embeddings.

FIG. 4 shows an example self-attention pattern 400 for 3D cross frame self-attention, according to an embodiment. As described above, the self-attention layer 318 of the noise processor 310 may be trained to have the self-attention pattern 400 for 3D cross frame self-attention. As shown in FIG. 4, the self-attention layer 318 may relate pixels of a first image 410 of a set of multi-view images with pixels of a second image 412 of the set of multi-view images. Accordingly, the self-attention layer 318 may provide improved consistency among multi-view images after training using multi-view images of a same subject, as described above.

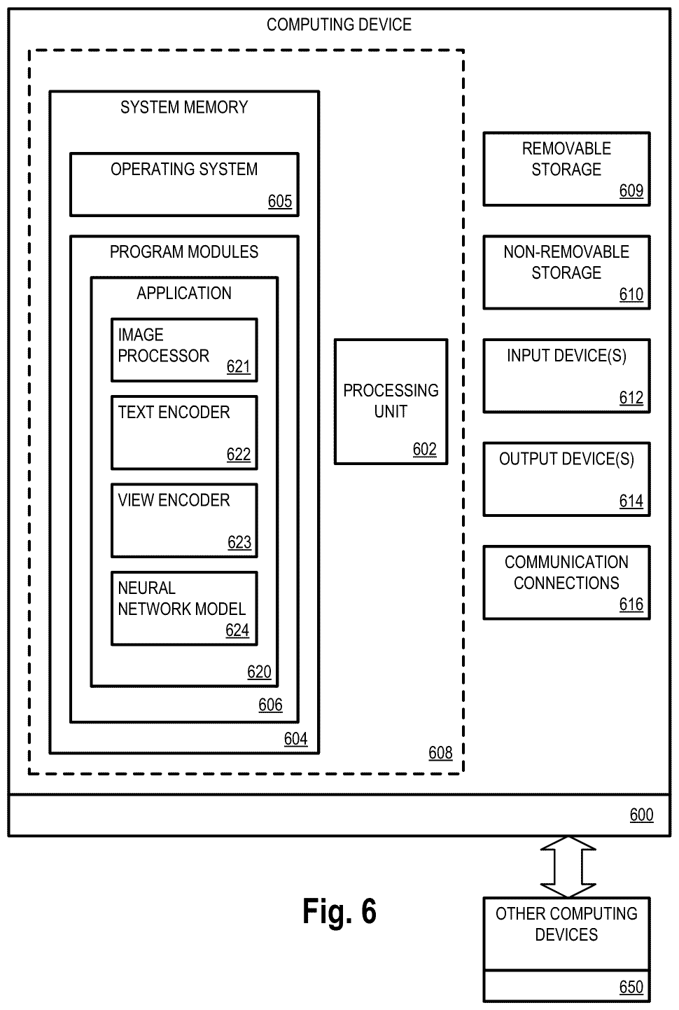

FIG. 5 shows a flowchart of an example method 500 for training an image processor having a neural network model, according to an example embodiment. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 5. Steps may be performed serially, in a partially overlapping manner, or fully in parallel. Thus, the order in which steps of method 500 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 5 may be performed by the computing device 120 (e.g., via the image processor 112 and/or the neural network model 118), the image processor 300, or other suitable computing device.

Method 500 begins with step 502. At step 502, a first training batch that comprises a plurality of sets of 3D images is generated. Each 3D image within a set of 3D images has a same subject and a different view orientation. In one example, the computing device 110 generates the first training batch to include the set 302 of multi-view images shown in FIG. 3, along with additional sets (not shown for clarity). As shown in FIG. 3, the subject of the set 302 is the bulldog wearing a pirate hat and the multi-view images have four images with a front view orientation, a left side view orientation, a right side view orientation, and a rear view orientation, respectively. In some examples, the first training batch may further comprise a plurality of individual 2D images having different subjects from each other.

At step 504, respective view embeddings are generated as inputs for the neural network model. The respective view embeddings represent the different view orientations. For example, view embeddings for each of the set 302 of multi-view images are generated by the view encoder 314. In some examples, generating the respective view embeddings is performed using a multi-layer perceptron.

At step 506, the neural network model of the image processor is trained for multi-view image diffusion using the first training batch and the view embeddings. For example, one or more of the noise processor 310, the encoder 302, and the decoder 322 may be trained using the first training batch. In some examples, step 506 includes relating pixels across images within a set of 3D images using a self-attention layer of the neural network model. For example, the self-attention layer 318 of the noise processor 310 may relate pixels across the images within the set 302 of images. Generally, a diffusion timestep is shared among each 3D image within the set of 3D images when training the neural network model.

Step 506 may also include combining the respective view embeddings with a corresponding diffusion timestep as a residual for the neural network model. For example, the view embedding from the view encoder 314 may be combined with the timestep 320 by the embedding processor 306 and provided to the noise processor 310 (e.g., to the cross attention layer).

In some examples, each 3D image within the set of 3D images corresponds to a same input prompt. In other words, a same instance of the prompt 342 may be used to generate the set 302 of multi-view images so that each image has a same subject, where the prompt may be a description of the subject. Accordingly, training the neural network model may include generating a text embedding that represents the same input prompt and providing the text embedding to a cross attention layer of the neural network model, where the text embedding is combined with the view embeddings. For example, when the computing device 110 generates suitable sets of 3D images for training the image processor 112 by rendering a set of multi-view images for each subject from a separate 3D dataset, a description of the subject from the 3D dataset may be used as the prompt 342. The 3D images, for each set of 3D images, may be generated to have view orientations having a same elevation angle at uniformly distributed azimuth angles.

In some examples, the method 500 further includes pre-training the neural network model as a 2D diffusion model for transfer learning. For example, the image processor 300 may be trained as a 2D diffusion model using 2D priors. Moreover, training the neural network model may further comprise fine-tuning the neural network model using the plurality of sets of 3D images and the plurality of individual 2D images. In some examples, fine-tuning includes receiving a plurality of identity text/image pairs of a subject and fine-tuning parameters of the neural network model using a parameter preservation loss (described below).

In some examples, the method 500 further includes generating a second training batch similar to the first training batch and fine-tuning the image processor 300 using the second training batch.

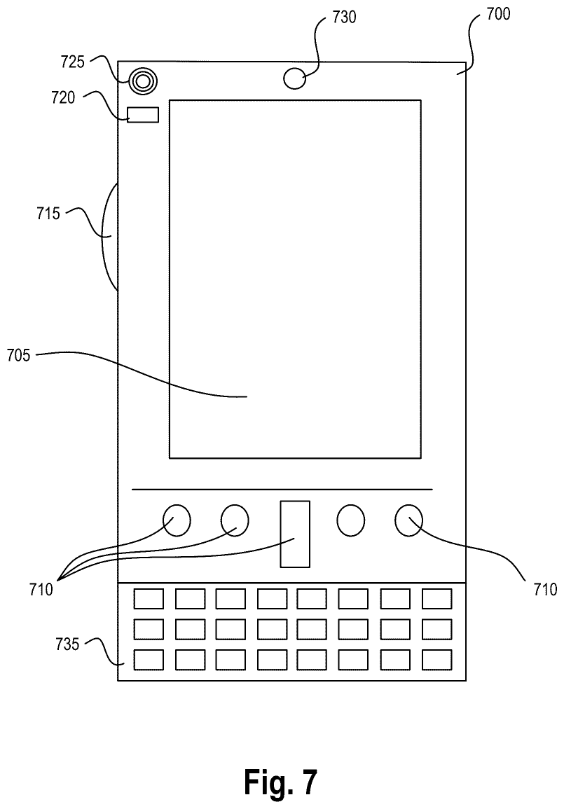

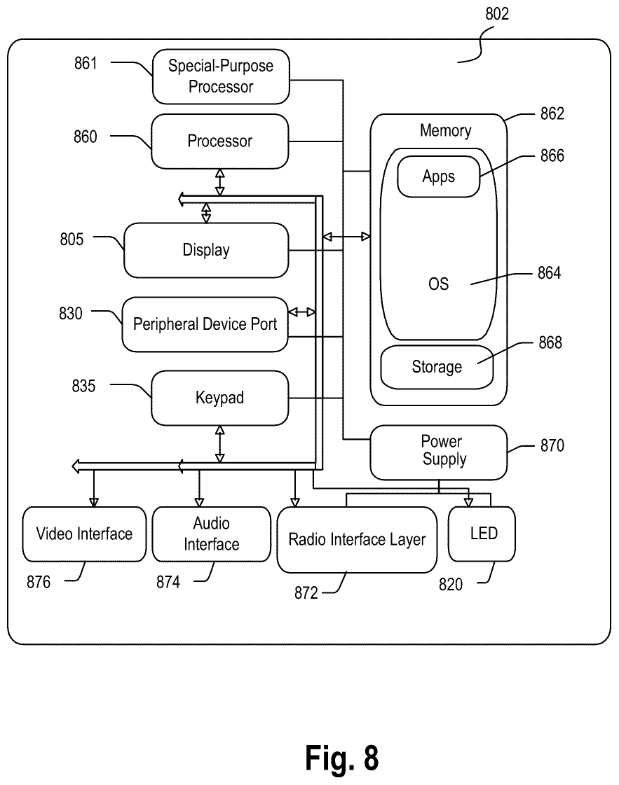

FIGS. 6 and 7 and the associated descriptions provide a discussion of a variety of operating environments in which aspects of the disclosure may be practiced. However, the devices and systems illustrated and discussed with respect to FIGS. 6 and 7 are for purposes of example and illustration and are not limiting of a vast number of computing device configurations that may be utilized for practicing aspects of the disclosure, as described herein.

FIG. 6 is a block diagram illustrating physical components (e.g., hardware) of a computing device 600 with which aspects of the disclosure may be practiced. The computing device components described below may have computer executable instructions for implementing an image processor application 620 on a computing device (e.g., computing device 110 or 120), including computer executable instructions for image processor application 620 that can be executed to implement the methods disclosed herein. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running image processor application 620, such as one or more components with regard to FIGS. 1 and 2, and, in particular, image processor 621 (e.g., corresponding to image processor 112 or image processor 300), text encoder 622 (e.g., corresponding to text encoder 116 or text encoder 316), view encoder 623 (e.g., corresponding to view encoder 114 or view encoder 314), and neural network model 624 (e.g., corresponding to neural network model 118 or neural network model 128).

The operating system 605, for example, may be suitable for controlling the operation of the computing device 600. Furthermore, examples of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., image processor application 620) may perform processes including, but not limited to, the aspects, as described herein. Other program modules that may be used in accordance with aspects of the present disclosure, and in particular for training an image processor, may include image processor 621, prompt processor 622, augmentation processor 623, and/or neural network model 624.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Examples of the disclosure may also be practiced using other technologies capable of performing logical operations such as, for example, AND, OR, and NOT, including but not limited to mechanical, optical, fluidic, and quantum technologies. In addition, examples of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIG. 7 illustrates a mobile computing device 700, for example, a mobile telephone, a smart phone, wearable computer (such as a smart watch), a tablet computer, a laptop computer, and the like, with which examples of the disclosure may be practiced. In some aspects, the client may be a mobile computing device. With reference to FIG. 7, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some examples. In yet another alternative example, the mobile computing device 700 is a portable phone system, such as a cellular phone. The mobile computing device 700 may include a front-facing camera 730. The mobile computing device 700 may also include an optional keypad 735. Optional keypad 735 may be a physical keypad or a “soft” keypad generated on the touch screen display. In various examples, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 8 is a block diagram illustrating the architecture of one aspect of a mobile computing device. That is, the mobile computing device 700 can incorporate a system (e.g., an architecture) 802 to implement some aspects. In one example, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone. The system 802 may include a display 805 (analogous to display 705), such as a touch-screen display or other suitable user interface. The system 802 may also include an optional keypad 835 (analogous to keypad 735) and one or more peripheral device ports 830, such as input and/or output ports for audio, video, control signals, or other suitable signals.

The system 802 may include a processor 860 coupled to memory 862, in some examples. The system 802 may also include a special-purpose processor 861, such as a neural network processor. One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as email or other messages used by an email application, and the like. A synchronization application (not shown) also resides on the system 802 and is programmed to interact with a corresponding synchronization application resident on a host computer to keep the information stored in the non-volatile storage area 868 synchronized with corresponding information stored at the host computer.

The system 802 has a power supply 870, which may be implemented as one or more batteries. The power supply 870 may further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via an audio transducer 725 (e.g., audio transducer 725 illustrated in FIG. 7). In the illustrated example, the visual indicator 820 is a light emitting diode (LED) and the audio transducer 725 may be a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 725, the audio interface 874 may also be coupled to a microphone to receive audible input, such as to facilitate a telephone conversation. In accordance with examples of the present disclosure, the microphone may also serve as an audio sensor to facilitate control of notifications, as will be described below. The system 802 may further include a video interface 876 that enables an operation of peripheral device 830 (e.g., on-board camera) to record still images, video stream, and the like.

A mobile computing device 700 implementing the system 802 may have additional features or functionality. For example, the mobile computing device 700 may also include additional data storage devices (removable and/or non-removable) such as, magnetic disks, optical disks, or tape. Such additional storage is illustrated in FIG. 8 by the non-volatile storage area 868.

Data/information generated or captured by the mobile computing device 700 and stored via the system 802 may be stored locally on the mobile computing device 700, as described above, or the data may be stored on any number of storage media that may be accessed by the device via the radio interface layer 872 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 872 or via a distributed computing network. Similarly, such data/information may be readily transferred between computing devices for storage and use according to well-known data/information transfer and storage means, including electronic mail and collaborative data/information sharing systems.

As should be appreciated, FIGS. 7 and 8 are described for purposes of illustrating the present methods and systems and is not intended to limit the disclosure to a particular sequence of steps or a particular combination of hardware or software components.

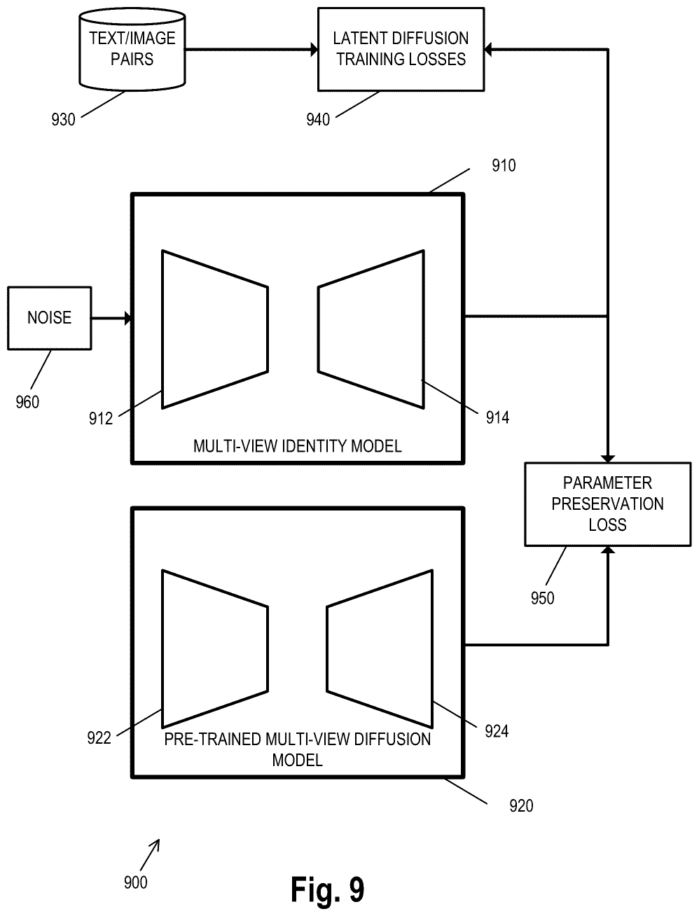

FIG. 9 shows a block diagram 900 illustrating an example process for fine tuning a neural network model 910, according to an example embodiment. The neural network model 910 may be fine-tuned according to an identity of a subject (“identity fine-tuning”), based on a pre-trained multi-view diffusion model 920. In this way, the neural network model 910 is trained as a multi-view identity model, or more specifically, fine-tuned after some prior training, to generate images from text prompts where the images incorporate the subject.

The neural network model 910 may generally correspond to the image processor 300. For example, the neural network model 910 may include an encoder 912 and a decoder 914 that correspond to the encoder 302 and decoder 322 of the image processor 300. Similarly, the pre-trained multi-view diffusion model 920 may include an encoder 922 and a decoder 924 that correspond to the encoder 302 and decoder 322.

Identity fine-tuning may be based on a “frozen” instance of the multi-view diffusion model, for example, the image processor 300 where parameters (or weights) of the model are frozen after being trained, shown as the pre-trained multi-view diffusion model 920, where the further training of the model 910 results in updated parameters according to a parameter preservation loss function 950 and latent diffusion training losses 940. The parameter preservation loss function 950 may be used to avoid overfitting and language-drift of the neural network model 910.

In the example shown in FIG. 9, text/image pairs 930 include images of a subject and sample text for those images. The text/image pairs 930 may comprise 3 to 5, or more images of the subject. During fine-tuning of the neural network model 910, the neural network model 910 receives noise 960 (e.g., noisy image 312) and learns suitable parameters according to the latent diffusion training losses 940 to generate an image from the text/image pairs 930 that is conditioned on the corresponding text. However, the parameters are subject to the parameter training loss. In the example shown in FIG. 9, the parameter training loss is defined as:

$${\sum }_{θ} \vert {θ}_{f} - {θ}_{db} \vert$$

where θ is a parameter, θ_{f} is a corresponding frozen parameter of the pre-trained multi-view diffusion model 920, θ_{db} is the corresponding parameter of the multi-view identity model 910, and an L1 loss is used for regularization. This approach improves preservation of a generative ability from the prior training. In some examples, the neural network model 910 is trained using a batch size of four images for approximately 400 epochs.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In other configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

What is claimed is:

1. An image generation system, comprising:
a neural network model configured to perform a diffusion process to generate a set of multi-view images from a same input prompt, the set of multi-view images having a same subject from different view orientations;
wherein the neural network model comprises a self-attention layer configured to relate pixels across the set of multi-view images.

2. The image generation system of claim 1, wherein the neural network model comprises a view encoder configured to generate respective view embeddings as inputs that represent the different view orientations.

3. The image generation system of claim 2, wherein each view embedding is combined with a corresponding diffusion timestep as a residual for the neural network model.

4. The image generation system of claim 2, wherein the neural network model further comprises a cross attention layer configured to receive a text embedding that represents the same input prompt, wherein the text embedding is combined with the view embeddings.

5. The image generation system of claim 2, wherein the view encoder is a multi-layer perceptron.

6. The image generation system of claim 1, wherein the neural network model is trained using a plurality of sets of 3D images, each 3D image within a set of 3D images having a same subject and a different view orientation.

7. The image generation system of claim 6, wherein a diffusion timestep is shared among each 3D image within the set of 3D images.

8. The image generation system of claim 6, wherein the neural network model is further trained using a plurality of individual 2D images having different subjects from each other.

9. The image generation system of claim 8, wherein the view embedding is omitted for the plurality of individual 2D images.

10. The image generation system of claim 8, wherein the neural network model is based on a pre-trained 2D diffusion model for transfer learning and is fine-tuned using the plurality of individual 2D images and the plurality of sets of 3D images.

11. A method for training an image processor having a neural network model, the method comprising:
generating a first training batch that comprises a plurality of sets of 3D images, each 3D image within a set of 3D images having a same subject and a different view orientation;
generating respective view embeddings as inputs for the neural network model that represent the different view orientations; and
training the neural network model of the image processor for multi-view image diffusion using the first training batch and the view embeddings.

12. The method of claim 11, wherein training the neural network model of the image processor comprises relating pixels across images within a set of 3D images using a self-attention layer of the neural network model.

13. The method of claim 12, wherein training the neural network model of the image processor comprises combining the respective view embeddings with a corresponding diffusion timestep as a residual for the neural network model.

14. The method of claim 12, wherein each 3D image within the set of 3D images corresponds to a same input prompt;
wherein training the neural network model comprises:
generating a text embedding that represents the same input prompt, wherein the text embedding is combined with the view embeddings; and
providing the text embedding to a cross attention layer of the neural network model.

15. The method of claim 11, wherein generating the respective view embeddings comprises generating the respective view embeddings using a multi-layer perceptron.

16. The method of claim 11, wherein generating the first training batch that comprises the plurality of sets of 3D images comprises generating 3D images, for each set of 3D images, to have view orientations having a same elevation angle at uniformly distributed azimuth angles.

17. The method of claim 16, wherein generating the first training batch further comprises generating a plurality of individual 2D images having different subjects from each other.

18. The method of claim 17, further comprising:
pre-training the neural network model as a 2D diffusion model for transfer learning; and
fine-tuning the neural network model using the plurality of sets of 3D images and the plurality of individual 2D images.

19. The method of claim 18, wherein fine-tuning the neural network model comprises:
receiving a plurality of identity text/image pairs of a subject; and
fine-tuning parameters of the neural network model using a parameter preservation loss.

20. The method of claim 16, wherein training the neural network model comprises sharing a diffusion timestep among each 3D image within the set of 3D images.
